(19) United States
(12) Patent Application Publication
(10) Pub. No.: US 2009/0093365 A1
(43) Pub. Date: Apr. 9, 2009

(54) Multilayer seed coating

(76) Inventors: John F. Walsh, Linden, CA (US); Mike Harnden, Manteca, CA (US); Roger Gill, Delhi, CA (US)

Correspondence Address: BAYER CROPSCIENCE LP, Patent Department, 2 T .W. ALEXANDER DRIVE, RESEARCH TRIANGLE PARK, NC, 27709, US

(21) Appl. No.: 12/283,026

(22) Filed: Sep. 9, 2008

Related U.S. Application Data
(60) Provisional application No. 60/978,313, filed on Oct. 8, 2007.

(51) Int. Cl. A01C 1/06; A01N 25/26

(52) U.S. Cl. 504/100; 424/405; 427/4

(57) ABSTRACT

In accordance with the present invention, various types of seeds are coated with a coating comprising a) a base buildup layer comprising a porous composition such as pumice; b) an intermediate build up layer comprising a silicate composition such as talc or mica; and c) an outer layer comprising a carbon-based composition such as graphite. A binder is optionally added to one or more layers. Preferably, each layer is applied to a seed in either a batch or continuous process using conventional methods of coating. Hybrid corn and sunflower seeds may be coated in accordance with the present invention resulting in a substantially uniform size seed.

### BACKGROUND OF THE INVENTION

1. Field of the Invention

The present invention relates generally to the coating of plant seeds. More specifically, the present invention relates to seed coating compositions, methods of applying the compositions and the coated seeds produced thereby.

2. Description of Related Art

Coating plant seeds prior to planting is a common practice in modern agriculture. As a crop protection, seed coatings offer many benefits in comparison to traditional methods that require the use of expensive and complex chemical application equipment. Seed coatings also may comprise a variety of useful additivess such as a fungicide, bactericide or insecticide to protect against disease, polymer coatings to delay germination, pH modifiers and various nutrients. Additionally, coatings can contain a coloring agent which provides visibility during seed placement, identification of grade or variety as well as differentiation between sellers. A further advantage to coating seeds is the additional weight the coating adds to each seed. The additonal weight renders the seeds more resistant to water and wind erosion.

A coating may also enlarge smaller seeds. The process of adding such a coating is referred to as “encrusting” or “build-up coating” and is commonly performed on small seeds such as those for grass. While encrusting or build-up coating of seeds may increase the overall size and weight of small seeds, these processes may not create uniform size and shape. Larger and more uniform seed size and shape is advantegous to the seed producer and farmer, especially in the case of corn. A typical ear of corn is substantially cylindrical in shape with a tapered region at one end of the ear. The taper in the ear results in smaller kernels of corn at the tapered end compared to that of the cylindrical region of the ear.

Small seeds, such as kernels originating from a tapered end of corn, pose a serious problem for both the planter and seed producer. For the corn seed producer, the kernels from the tapered region are separated and sold for a substantially lower price compared to that of the kernels emerging in the cylindrical region of the ear. As a result, the seed producer incurs a loss of potential profit due to the prescence of these smaller kernels. Alternatively, these smaller kernels may be processed and sold as animal feed for substantially lower price compared to the price of larger corn kernels. For the grower, small kernels not separated prior to planting may disrupt the intermediate flow of kernels through the planter and may cause two or more, and sometimes no kernels to be planted in one region. Thus, smaller kernels cause a lower planting efficiency and loss of profit for the grower.

Hybrid corn offers distinct agricultural advantages over other types of corn. Industry attempts to produce a uniform size hybrid corn seed, however, have proven futile. Thus, there exists a need for seed coating and process for coating seeds that maximizes profit for the seed producer and increases planting efficiency for the grower. Specifically, there exists a need for a coating that can be applied to both small and large hybrid corn kernels in a manner to create a substantially uniform shape and size seed without sacrificing stand count. The present invention provides such seeds, seed coating compositions and processes of applying such compositions.

### SUMMARY OF THE INVENTION

The present invention provides a seed coating composition having a base build up layer comprising a porous composition, an intermediate build up layer comprising a silicate composition and an outer layer comprising a carbon-based composition. The base build up layer comprises a porous composition having an abrasive, particulate matter such as pumice. Preferably, the porous composition further comprises a binder to help adhere the porous composition to the uncoated seed. The binder preferably comprises a combination of polymers and copolymers of polyvinyl alcohol and a sugar such as sucrose.

The intermediate layer builds on the base layer and preferably comprises a silicate composition such as talc or mica or a combination thereof. The outer layer comprises a slick composition having a carbon-based composition such as graphite to further aid in the flow of the seed through planting equipment. The amount of each layer applied to the seeds depends on both the starting size and/or weight of the seed and the target size and/or weight after coating. Any one or more of the layer compositions may further comprise at least one additive such as a colorant, a fungicide, insecticide, or other pesticide, and any combination thereof.

The present invention also provides processes for the coating of seeds which comprises the steps of providing an uncoated seed, applying a base, intermediate and outler layer coating composition to the seed and drying the seed. The present processes are carried out in either a batch or continuous process using conventional methods of coating. Preferably, the invention involves applying a first, or base layer with a binder to the previously selected small, uncoated seed. The intermediate layer and outer layer coating compositions are preferably sequentially added to the base layer with a binder. The coated seeds are optionally polished and placed in a controlled dryer chamber for drying. The dried seeds are packaged and stored for planting. Prior to storage, the dried seeds may be blended with seeds of substantially uniform size, shape and aesthetic appearance that only received an additive coating (i.e., those seeds of target size from the cylindrical portion of the corn's ear).

Vegetable seeds such as hybrid corn and sunflower seeds are preferably coated in accordance with the present invention resulting in a substantially uniform seed. Preferably, the resulting seeds are substantially uniform in size with a variation of size of less than about 25%. The foregoing and other aspects of the present invention are explained in detail in the detailed description and examples set forth below.

### DETAILED DESCRIPTION OF THE INVENTION

In accordance with the present invention, various types of seeds are coated with a coating comprising one or more layers of a) a base layer comprising a porous composition such as pumice; b) an intermediate layer comprising a silicate composition such as talc or mica; and c) an outer outside layer comprising a carbon-based composition such as graphite. In one embodiment, each composition is combined with a binder and applied to a seed in either a batch or continuous process using conventional methods of coating. The resulting seed exhibits up to about a 125% increase in weight and a substantially uniform shape and size among the coated seeds. Furthermore, seeds coated according to the present invention demonstrate sufficient hardness to improve overall plantability.

Any crop seed can be treated in accordance with the invention such as fruits and vegetables. In one embodiment, the crop seeds that may be coated include sweet corn, soybean, wheat, barley, rice, cotton, rapeseed, sugarbeet, tomato, bean, carrot, tobacco and some flower seeds. In a preferred embodiment, hybrid corn or sunflower seeds are coated with accordance with the present invention.

### Base Layer

In one embodiment, a base layer is applied directly to an uncoated seed. In a preferred embodiment, the base layer comprises a porous composition. The porous composition comprises an abrasive, particulate material and a suitable binder. The porous composition not only increases the overall size of the seed but allows for oxygen and water uptake required for seed germination. Preferably, the abrasive, particulate material is a finely ground pumice. The base layer may increase the overall weight of the seed by up to or about 50%. The thickness of the base layer depends on both the beginning size of the seed and target size for the seed but typically ranges of from about 0.05 mm to about 1 mm and comprises from about 5% to about 65% of the seed. The amount of binder present within the porous composition will range from about 35% w/w to about 75% w/w of the buildup layer and preferably from about 50% w/w to about 60% w/w.

Suitable binders that may be combined with any one of the seed coatings described herein are those composed preferably of an adhesive polymer that may be natural or synthetic and is without phytotoxic effect on the seed to be coated. In one embodiment, the binder may be a molasses, granulated sugar, alginates, karaya gum, jaguar gum, tragacanth gum, polysaccharide gum, mucilage or combination thereof. In another embodiment, the binder may be selected from polyvinyl acetates, polyvinyl acetate copolymers, polyvinyl alcohols, polyvinyl alcohol copolymers, celluloses, including ethylcelluloses and methylcelluloses, hydroxymethyl celluloses, hydroxypropylcelluloses, hydroxymethylpropyl-celluloses, polyvinylpyrolidones, dextrins, malto-dextrins, polysaccharides, fats, oils, proteins, gum arabics, shellacs, vinylidene chloride, vinylidene chloride copolymers, calcium lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof. Other suitable binders include polymers and copolymers of vinyl acetate, methyl cellulose, vinylidene chloride, acrylic, cellulose, polyvinylpyrrolidone and polysaccharide. Still other suitable binders include polymers and copolymers of vinylidene chloride and vinyl acetate-ethylene copolymers.

In a preferred embodiment, the binder includes a combination of polyvinyl alcohol and a sugar such as sucrose. The binder may optionally contain a plasticizer to fascilitate coating. Suitable plasticizers include glycerol, propylene glycol, and polyglycols. The plasticizer, when added, comprises from about 0.5% to 10% w/w of the binder.

### Intermediate Layer

In one embodiment, an intermediate layer is applied to the seed. In a preferred embodiment, the intermediate layer is applied directly over the base layer to create a smoother, more uniform surface. If left uncoated, the exposed rough base layer may damage or stick to planting equipment due to uneven contact and friction created between the planting equipment and the rough outer surface of the seed's base layer.

The intermediate layer preferably contains a composition that comprises a filler such as clay or other inorganic solid for smoothing the base layer and a suitable binder as disclosed herein. In one embodiment, the filler is a clay or other inorganic solid such as calcium bentonite, kaolin, china clay, talc, perlite, mica, vermiculite, silicas, quartz powder, montmorillonite and mixtures thereof. Other suitable fillers include woodflours, clays, activated carbon, sugars such as dextrin or maltodextrin, diatomaceous earth, cereal flours such as wheat flour, oat flour and barley flour, fine-grain inorganic solids, calcium carbonate and the like. The inorganic material may be a combination of one or more finely ground silicates. In a preferred embodiment, the filler is a talc or a member of the mica family or a chemical equivalent thereof, alone or in combination. The intermediate layer may have a thickness in the range of from about 0.05 mm to about 1 mm depending on the beginning and target size of the seed and comprises from about 5% w/w to about 65% w/w of the seed.

### Outer Layer

In one embodiment, an outer layer is applied directly over the intermediate layer. The outer layer comprises a slick or slippery composition that comprises an inert particulate material or liquid lubricant and, optionally, a binder. The inert particulate material may comprise one or more carbon-based compositions. In a preferred embodiment, the carbon-based composition is graphite. The carbon-based composition may be combined with a magnesium silicate such as talc. The inert particulate material comprises from about 0.2% w/w to about 5% w/w of the seed weight and more preferably from about 2% w/w to about 4% w/w. The binder may be one or more of the suitable binders previously described.

The seed coated with the outler layer is advantageous to the grower because the slick outler layer further improves seed flow through the planting equipment. The outer layer reduces or eliminates the need for the grower to introduce talc or graphite into the planting equipment to facilitate seed flow. The outler layer may have a thickness in the range of from about 0.0005 mm to about 0.1 mm depending on the beginning and target size of the seed and comprises from about 2% to about 4% of the seed.

### Additives

In one embodiment, the compositions comprising the various seed coating layers may also contain one or more other additives such as insecticides, nematicides, fungicides, disinfectants, repellents and growth regulators, agents capable of protecting seeds from the harmful effects of selective herbicides such as activated carbon, nutrients (fertilizers), agents capable of improving the germination and quality of the products, bacteria capable of exerting a favorable effect on the germination or a combination thereof.

One or more layers of additives may be placed on the seed either before or after applying any one or more of the coating layers described herein. Alternativley, one or more additives may be added into any one or all of the coating layer compositions described herein. The amount of additive introduced will depend on the desired characteristics of the seed and the type of seed but will generally range from about 0.01% w/w to about 3% wIwI of the seed. An initial layer of one or more clay or peat based inoculants such as rhizobia inoculants may also be applied to seeds to increase nodulation.

Suitable insecticides include those selected from pyrethoids, organophosphates, caramoyloximes, pyrazoles, amidines, halogenated hydrocarbons, and carbamates and derivatives thereof. Particularly suitable classes of insecticides include organophosphates, phenylpyrazoles and pyrethoids. Preferred insecticides are those know as terbufos, chlorpyrifos, fipronil, chlorethoxyfos, tefluthrin, carbofuran, imidacloprid, clothianidin, and tebupirimfos. Also included are insect growth regulators for example, methoprene and hydroprene.

Suitable fungicidal or bactericidal agents may include phenylpyrrole fungicides, such as fenpiclonil and fiudioxonil, azole fungicides such as trifiumizol, propiconazole and tebuconazole, and strobilurine fungicides such as azoxystrobin. The seed may also comprise a colorant or colorant containing coating composition, especially those seed having a fungicidal agent. Suitable colorants include any organic chromophores having a polyoxyalkylene substituent. Any of a variety of chromophores may be employed, including organic chromophores classified as nitroso, nitro, azo, including monoazo, bisazo and polyazo, diphenylmethane, triarylmethane, xanthene, methine, acridine, thiazole, thiazine, indamine, indophenol, azine, oxazine, anthraquinone and phthalocyanine.

Suitable herbicides include those selected from carbamates, thiocarbamates, acetam ides, particularly chloroacetam ides, triazines, dinitroanilines, glycerol ethers, pyridazinones, uracils, phenoxys, ureas, and benzoic acids and derivatives. Suitable safeners include for example, benzoxazine, benzhydryl derivatives, N,N-diallyl dichloroacetamide, various dihaloacyl, oxazolidinyl and thiazolidinyl compounds, ethanone, naphthalic anhydride compounds, and oxime derivatives. In one embodiment, a safener is added either alone or in combination with the herbicide to protect the seed against potentially harmful chemicals in the soil and to compensate for or reduce the phytotoxic properties of the herbicide.

### Coating Process

According to the present invention, the seeds are substantially uniformly coated with one or more of the aforementioned layers of compositions using conventional methods of mixing, spraying or a combination thereof. Various coating machines are available which may utilize various coating technology through the use of rotary coaters, drum coaters, fluidized bed techniques, spouted beds or a combination thereof.

The seeds may be coated via a batch or continuous coating process. In one embodiment, uncoated seeds enter the coating machine in a steady stream to replace coated product that has exited the machine. Additionally, a computer system may monitor the seed input to the coating machine, thereby maintaining a constant flow of the appropriate amount of seed. In an alternative embodiment, the seed coating machinery can optionally be operated by a programmable logic controller that allows various equipment to be started and stopped without employee intervention. The components of this system are commercially available through several sources.

In one embodiment, harvested seeds such as small hybrid corn kernels that would typically sell for a lower price or cause decreased planting efficiency are first separated by mechanical means such as a sieve. Separating the seeds based on size allows only the targeted small seeds to receive one or more coating layers so that one or more uniformly sized seeds are ultimately produced. The larger, target-sized seeds may be set aside for coating with one or more additives such as a colorant so that these larger seeds have a similar appearance to those smaller seeds receiving one or more of the coatings described herein.

The separated small seeds are then introduced into a coating machine via an infeed chute that allows for precision metering of incoming seeds. After passing through the infeed chute, the seed enters a mixing bowl. In one embodiment, the mixing bowl is one or more cylinders with a rotating base. One or more coating compositions are then introduced to the mixing bowl via a powder feeder and/or solution pumps. In one embodiment, the powder feeder applies the one or more coating compositions to the seeds as the seed mass rotates in the mixing bowl. In a preferred embodiment, the seeds are combined with one or more of the coating compositions and adhered with the binder within a mixing bowl. Either the operator or a computer system may verify and coordinate any batching, mixing, and pumping of the solutions containing one or more of the coating layer compositions.

In one embodiment of the process, all three layer compositions are sequintially added. Preferably, the base layer comprising a polyvinyl alcohol and sucrose binder as well as a pumice are added to the mixing bowl containing one or more seeds. The intermediate and outer compositions are then introduced sequentially to the rotating drum. The intermediate composition preferably comprises talc or mica while the outer layer preferably comprises graphite alone or in combination with a magnesium silicate such as talc. In one embodiment, the seeds are polished by retaining the seeds in the mixing bowl for an extended period of time resulting in an improved appearance.

After application of one or more of the layers described herein, the seed exits the mixing bowl and is moved to a drying apparatus where the seed is dried. In one embodiment, the dried seeds are transferred back to the infeed chute for subsequent coating. In an alternative embodiment, the resulting dried, coated seeds are bagged and stored for future use. In the case of hybrid corn, the smaller kernels comprising one or more of the layers described herein may be combined with the larger kernels originating from the cylindrical region of the ear of corn. The larger kernels originiating from the cylindrical region of the corn may comprise a thin coating having an additive such as a colorant so that the small kernels and larger kernels may not be differentiated by the purchaser. In one embodiment, the resulting kernels are medium round and substantially uniform in size with a variation in size of less than about 35%. Preferably, the size variation among seeds presented to the purchaser is less than about 15% and more preferably less than about 5%.

Having disclosed the subject matter of the present invention, it should be apparent that many modifications, substitutions and variations of the present invention are possible in light thereof. It is to be understood that the present invention can be practiced other than as specifically described. Such modifications, substitutions and variations are intended to be within the scope of the present application.

1. A seed coating comprising
a base buildup layer comprising a porous composition;
an intermediate build up layer comprising a silicate composition; and
an outer layer comprising a carbon-based composition.

2. The seed coating of claim 1, wherein the base build up layer comprises 5% w/w to 65% w/w of the seed.

3. The seed coating of claim 1, wherein the porous composition comprises pumice.

4. The seed coating of claim 1, wherein the intermediate layer comprises % w/w to 65% w/w of the seed.

5. The seed coating of claim 1, wherein the silicate composition is selected from a group consisting of talc, diatomataus earth, mica and a combination thereof.

6. The seed coating of claim 1, wherein the outer layer comprises 2% w/w to 4% w/w of the seed.

7. The seed coating of claim 1, wherein the carbon-based composition is graphite.

8. The seed coating of claim 1, wherein the porous composition, silicate composition and carbon-based composition optionally comprise a binder.

9. The seed coating of claim 8, wherein the binder comprises polyvinyl alcohol.

10. The seed coating of claim 9, wherein the binder further comprises sucrose.

11. The seed coating of claim 1, wherein one or more of the compositions further comprises at least one additive selected from the group consisting of a colorant, a fungicide, a herbicide, a pesticide, and any combination thereof.

12. A process for coating one or more seeds comprising the steps of:
providing at least one uncoated seed;
applying the seed coating claim 1 to the at least one seed; and
drying the coated seed.

13. The process of claim 12, wherein the overall weight of the seed is increased by up to 125%.

14. The process of claim 12, wherein the process is a batch or continuous process.

15. The process of claim 12, wherein each layer of the seed coating is applied to the seed via simultaneous addition to a mixing bowl.

16. The process of claim 12, wherein each layer of the seed coating is applied to the seed via sequential addition in a mixing bowl.

17. The process of claim 12, further comprising the step of polishing the seed.

18. The process of claim 12, wherein two or more coated seeds exhibit less than 35% variation is size.

19. A coated seed comprising a seed coated with a composition comprising
a seed; and
at least one coating composition applied to the seed wherein the coating composition comprises a porous composition, a silicate composition, a carbon-based composition, or a combination thereof.

20. The coated seed of claim 19, wherein the seed is selected from the group consisting of hybrid corn, sunflower, and vegetable seeds.

21. The coated seed of claim 19, wherein the coating composition further comprises at least one treatment selected from the group consisting of a colorant, a fungicide, a herbicide, a pesticide, and any combination thereof.
